(19) United States
(12) Patent Application Publication
(10) Pub. No.: US 2006/0045950 A1
(43) Pub. Date: Mar. 2, 2006

(54) Mineral preparation, raw material for the preparation, and methods for producing the mineral preparation and the raw material

(75) Inventors: Kenichi Inoue, Kusatsu-shi (JP); Shinsaku Takaoka, Kuze-gun (JP)

Correspondence Address: THE WEBB LAW FIRM, P.C., 700 KOPPERS BUILDING, 436 SEVENTH AVENUE, PITTSBURGH, PA, 15219, US

(73) Assignee: Japan Bio Science Laboratory Co., Ltd.

(21) Appl. No.: 11/066,347

(22) Filed: Feb. 25, 2005

(30) Foreign Application Priority Data
Aug. 27, 2004 (JP) 2004-248417

(51) Int. Cl. C12H 1/04

(52) U.S. Cl. 426/442

(57) ABSTRACT

A raw material for a mineral preparation of the present invention can be obtained by calcining defatted sesame, and a mineral preparation containing minerals that can be absorbed into the body effectively can be obtained by recovering minerals from this raw material.

### BACKGROUND OF THE PRESENT INVENTION

1. Field of the present invention

The present invention relates to a mineral preparation, a raw material for the mineral preparation, and methods for producing the same. The present invention further relates to a method for obtaining minerals from defatted sesame.

2. Description of the Related Art

Sesame seeds contain about 50 wt % lipid and are used as a raw material for sesame oil. On the other hand, the remaining oil cake that is obtained by pressing the sesame seeds and removing the oil, namely, defatted sesame that corresponds to about 50 wt % of the sesame seeds is hardly used effectively. This defatted sesame had been heated considerably in the process of pressing the sesame seeds and removing the oil, so that it has dark brown color and presents an offensive taste and offensive odor due to, for example, decomposed proteins. Therefore, it is difficult to use defatted sesame for food material without any treatment, and almost all of it is disposed as industrial waste.

Recently, the use of defatted sesame focusing on the active components contained in the defatted sesame have been proposed. For example, Japanese Laid-Open Patent Publication No. 10-276662 discloses a mixed edible powder that contains the defatted sesame and an edible powder that is at least one of bean flour, grain flour, potato flour, and various starches in a specific ratio. This mixed edible powder was designed so as to utilize the characteristics of defatted sesame of having a low content of lipid and having high contents of proteins and sesaminol 3-glycoside. Furthermore, Japanese Laid-Open Patent Publication No. 11-246427 discloses that a methanol-soluble and 1-butanol-soluble fraction extracted from defatted sesame contains sesamin or sesamol, so that the defatted sesame can be used as an agent for activating carbohydrate metabolism and lipid metabolism.

On the other hand, sesame seeds generally contain 35 mg/100 g or more of oxalic acid and 5000 mg/100 g or more of phytic acid. Oxalic acid and the phytic acid inhibit mineral absorption into the body and reduce the efficacy of minerals. For example, although sesame seeds, in particular, sesame seed coats have a high content of calcium, almost all of it is present in the form of calcium oxalate, and thus the rate of absorption of the calcium derived from the sesame seed coats is known to be low. Therefore, a method of calcining sesame seed coats so as to obtain a mineral preparation containing calcium that can be absorbed into the body effectively has been researched (see Japanese Patent No. 3189044). However, the mineral preparation has a high content of calcium, and there is a demand for a well-balanced mineral preparation that also abundantly contains minerals other than calcium, such as magnesium.

### SUMMARY OF THE PRESENT INVENTION

An object of the present invention is to provide a value-added food and medicine by effectively using defatted sesame, which is a by-product in the production of sesame oil.

The inventors of the present invention found the followings: a raw material for a mineral preparation can be obtained by calcining defatted sesame, wherein the raw material does not contain oxalic acid and phytic acid substantially; the raw material for a mineral preparation contains magnesium, calcium, and potassium in a higher degree and the content of magnesium is particularly high; the minerals can be obtained easily through extraction with an acidic aqueous solution; and the resultant minerals can be easily absorbed into the body; and thus the present invention was achieved.

A raw material for a mineral preparation of the present invention is obtained by calcining defatted sesame.

A method for producing a raw material for a mineral preparation of the present invention comprises calcining defatted sesame.

A mineral preparation of the present invention comprises minerals obtained from the above-described raw material for a mineral preparation.

In a preferred embodiment, the preparation comprises magnesium, calcium, and potassium, and wherein the ratio of the magnesium is 20 wt % or more based on the total weight of the magnesium, calcium, and potassium.

A method for producing a mineral preparation of the present invention comprises mixing the above-described raw material for a mineral preparation and an acidic aqueous solution, and recovering the resultant aqueous phase.

A method for obtaining minerals from defatted sesame of the present invention comprises calcining defatted sesame to obtain a raw material for a mineral preparation, mixing the raw material for a mineral preparation and an acidic aqueous solution, and recovering the resultant aqueous phase.

According to the present invention, a mineral preparation is obtained from defatted sesame, and the preparation contains a large amount of minerals and does not contain oxalic acid and phytic acid substantially. Since the oxalic acid and phytic acid are not contained substantially, minerals contained in the preparation can be absorbed into the body effectively. In particular, the present invention provides a mineral preparation that contains large amounts of magnesium, calcium, and potassium, and preferably, a preparation in which the content of magnesium is especially high can be provided.

### DESCRIPTION OF THE PREFERRED EMBODIMENT

According to the present invention, a raw material for a mineral preparation can be obtained by calcining defatted sesame, and a mineral preparation can be obtained by recovering minerals from this raw material for a mineral preparation. Hereinafter, the defatted sesame, the raw material for the mineral preparation, and the mineral preparation will be described in this order.

Defatted Sesame

In the present invention, defatted sesame refers to a residual substance obtained in a process of industrially producing sesame oil from sesame. More specifically, this defatted sesame is obtained by removing oil from sesame seeds by pressing.

The sesame as a raw material of the defatted sesame used in the present invention is seeds of an annual plant belonging to the sesame family, and may be any sesame used for food. Black sesame (black-colored sesame), white sesame (white-colored sesame), yellow sesame (yellow-colored sesame), golden sesame (gold-colored sesame), and other varieties can be used. It is possible to use pre-treated sesame such as dehulled sesame or roasted sesame. The dehulled sesame can be obtained by removing sesame seed coats by using a separator such as a rotary shifter, a rotary screen, a gravity separator (air classifier), or the like. The roasted sesame can be obtained by, for example, roasting sesame at a relatively high temperature.

Raw Material for Mineral Preparation

The raw material for a mineral preparation of the present invention can be obtained by calcining defatted sesame. When the defatted sesame is calcined, the contents of oxalic acid and/or phytic acid in the resultant calcined sesame, that is, the raw material for a mineral preparation become lower, and the minerals contained in the raw material can be reconstructed into a form that can be easily absorbed into the body. Furthermore, the concentrations of minerals also become higher. When the degree of calcining is low, a raw material for a mineral preparation that contains oxalic acid and/or phytic acid in small amounts is obtained. A raw material for a mineral preparation that contains substantially no oxalic acid and phytic acid is preferable.

The raw material for a mineral preparation of the present invention contains various minerals. The content of total of the minerals in the raw material for a mineral preparation of the present invention is generally 85 wt % or more, preferably 95 wt % or more, more preferably 98 wt % or more. As the minerals, magnesium, calcium, and potassium are mainly contained (hereinafter, these minerals are referred to as major minerals). There is no particular limitation regarding the contents of the major minerals. The magnesium content is preferably 5 g/100 g or more, more preferably about 7 g/100 g to 10 g/100 g. The calcium content is preferably 20 g/100 g or more, and more preferably 23 g/100 g to 30 g/100 g. The potassium content is preferably 8 g/100 g or more, and more preferably about 10 g/100 g to 15 g/100 g.

There is no particular limitation regarding the calcining temperature and the calcining time for obtaining the raw material for a mineral preparation of the present invention, and they can be determined as appropriate in accordance with the contents of oxalic acid and/or phytic acid. Defatted sesame is calcined generally at 300° C. or more for 30 minutes or more (preferably 60 minutes or more); preferably at 600° C. or more for 30 minutes or more (preferably 60 minutes or more); more preferably at 800° C. or more for 30 minutes or more (preferably 60 minutes or more); and even more preferably at 900° C. or more for 30 minutes or more (preferably 60 minutes or more). In order to obtain a raw material for a mineral preparation having low contents of oxalic acid and/or phytic acid and high contents of minerals, defatted sesame is calcined preferably at 800° C. to 1200° C. for 2 hours or more, and more preferably for 3 hours or more. It is particularly preferable to calcine defatted sesame at 800° C. to 1200° C. for 3 hours or more, in order to obtain a raw material for a mineral preparation that contains substantially no oxalic acid and phytic acid.

There is no particular limitation regarding the atmosphere in which defatted sesame is calcined, and a raw material for a mineral preparation can be obtained by, for example, calcining defatted sesame in the air. Defatted sesame can be calcined by, for example, indirect heating or direct burning. There is no particular limitation regarding the calcining apparatus, and, for example, a calcining oven or an electric oven, or the like can be used.

The raw material for a mineral preparation of the present invention has low contents of oxalic acid and/or phytic acid, contains minerals abundantly, and contains major minerals such as magnesium, calcium, and potassium in a well-balanced manner, and thus, the minerals can be easily absorbed into the body.

Mineral Preparation

The mineral preparation of the present invention contains minerals that are recovered from the above-described raw material for a mineral preparation. More specifically, the minerals are obtained adding an acidic aqueous solution to the raw material for a mineral preparation, and performing extraction with the solution. The minerals in the raw material for a mineral preparation are eluted into the aqueous phase by this extraction.

There is no particular limitation regarding the acidic aqueous solution used in the extraction, as long as it has a pH of less than 7.0. Preferably, it is an acidic aqueous solution that has a pH in the range of 4 to 6. Examples of the acidic aqueous solution include an aqueous solution containing an inorganic acid such as hydrochloric acid, sulfuric acid, or the like, and an aqueous solution containing an organic acid such as lactic acid, acetic acid, citric acid, and malic acid, or the like. In particular, it is preferable to use an acidic aqueous solution containing lactic acid or acetic acid. Alternatively, lactic acid solution obtained by fermentation, vinegar produced by fermentation, or wood vinegar solution can be preferably used.

There is no particular limitation regarding the amount of the acidic aqueous solution. In general, an excessive amount of acidic aqueous solution is added in such a manner that minerals contained in the raw material sufficiently react with the acid contained in the acidic aqueous solution. Regarding the amount of the acidic aqueous solution, the acidic aqueous solution may be added to the raw material for a mineral preparation (i.e., ash) gradually until gas (i.e., carbon dioxide gas) produced by reacting the acid with the minerals in the raw materials stops being produced. Furthermore, there is no particular limitation regarding the extracting temperature and the extracting time, and they can be determined as appropriate, based on the timing at which the gas stops being produced.

The minerals extracted in this manner are recovered in the form of an aqueous solution or a precipitate. The mineral preparation is obtained by separating the aqueous phase from the solid phase by using a method such as decantation, filtering, or centrifugal separation. Then, this mineral preparation may be powdered by employing a drying process that is generally employed by those skilled in the art, such as freeze drying, spray drying, or evaporation to dryness.

The mineral preparation of the present invention contains various minerals derived from the raw material for a mineral preparation. Among these minerals, it preferably contains the major minerals, namely, magnesium, calcium, and potassium. There is no particular limitation regarding the contents of these major minerals. The magnesium content is preferably 4 g/100 g or more, more preferably about 4.5 g/100 g to 7 g/100 g. The calcium content is preferably 4 g/100 g or more, more preferably 4.5 g/100 g to 7 g/100 g or more. The potassium content is preferably 6 g/100 g or more, more preferably about 7 g/100 g to 10 g/100 g.

The ratio of the magnesium, the calcium, and the potassium in the mineral preparation of the present invention is not particularly limited. The ratio of the magnesium in the major minerals, that is, the amount of the magnesium in the total amount of magnesium, calcium, and potassium is preferably 20 wt % or more, more preferably 25 wt % or more, even more preferably 28 wt % or more. The ratio of the calcium in the major minerals is preferably 20 wt % or more, more preferably 25 wt % or more. The ratio of the potassium in the major minerals is preferably 35 wt % or more, more preferably 40 wt % or more.

In the present invention, it is particularly preferable that the mineral preparation contains magnesium in the ratio of 25 wt % to 35 wt %, calcium in the ratio of 20 wt % to 35 wt %, and potassium in the ratio of 40 wt % to 50 wt % based on the amount of the major minerals contained in the preparation.

Examples of other minerals include iron, copper, zinc, manganese, selenium, sodium, and phosphorus. There is no particular limitation regarding the contents of these. The iron content in the mineral preparation is preferably 5 g/100 g or less, and more preferably 1 g/100 g or less. The copper content in the mineral preparation is preferably about 2 mg/100 g to 100 mg/100 g, and more preferably about 5 mg/100 g to 50 mg/100 g. The selenium content in the mineral preparation is preferably about 0.01 mg/100 g to 100 mg/100 g, and more preferably about 0.1 mg/100 g to 50 mg/100 g. The sodium content in the mineral preparation is preferably about 10 mg/100 g to 5 g/100 g, and more preferably about 100 mg/100 g to 1 g/100 g. The contents of the zinc and the manganese in the mineral preparation are each preferably about 0.01 mg/100 g to 20 mg/100 g, and more preferably about 0.05 mg/100 g to 20 mg/100 g. The phosphorous content in the mineral preparation is preferably about 100 mg/100 g to 10 g/100 g, and more preferably about 100 mg/100 g to 1 g/100 g.

The mineral preparation of the present invention has low contents of oxalic acid and phytic acid, and contains minerals that can be absorbed into the body effectively. There is no particular limitation regarding the dosage form of the mineral preparation of the present invention, and the mineral preparation can be used in the form of, for example, powders, granules, or pellets by using an excipient, if necessary, or in the form of a liquid preparation in which the mineral preparation is dissolved or dispersed in any solvent that is acceptable as a food or a medicine.

Magnesium, calcium, and potassium are contained in the mineral preparation of the present invention in a well-balanced manner, and thus when the minerals in the preparation are absorbed into the body, various superior effects of these can be exerted. Examples of these effects include an effect of preventing osteoporosis; an effect of preventing circulatory system diseases; an effect of preventing hyperlipidemia; an effect of suppressing an increase of serum cholesterol, neutral fat, or LDL-cholesterol; an effect of suppressing a decrease of HDL-cholesterol; and an effect of suppressing an elevation of blood pressure. This mineral preparation has a particularly high content of magnesium, and this magnesium makes a contribution to discharge excessive calcium from the body, so that it is possible to ingest minerals while suppressing an excessive ingestion of calcium.

### EXAMPLES

### Examples 1 to 3

### Preparation of Raw Material for Mineral Preparation

Defatted sesame (Lot No. 1) was loaded into an electric oven. The temperature was raised to 800° C., and the defatted sesame was calcined for 1 hour. Thus a calcined material (calcined material 1) was obtained. Calcined materials 2 and 3 were obtained by calcining in the same manner as described above except that the calcining time was set to 2 hours or 3 hours.

Ash content of the obtained calcined materials was measured by the following method. First, a nickel crucible was placed in an electric oven set to 550° C., and was dried for 1 hour. Next, the crucible was placed in a desiccator, was left for cooling for 30 minutes, and was weighed. This process of drying, cooling, and weighing was repeated until a difference between its measured weight and its previously measured weight became within 1 mg. The final measured weight was determined to be a constant weight (W₀ g) of the crucible. Then, each of the calcined materials was placed in this crucible, and the total weight was measured to determine the weight (W₁ g) of each of the calcined materials accurately. The crucible containing each of the calcined materials was heated by using a gas burner. After moisture was removed completely, the crucible was placed in the electric oven with its lid partially opened, and was dried for 1 hour. Then, the crucible was covered with the lid in the electric oven, and was placed in the desiccator. The crucible was left for cooling for 30 minutes, and was weighed. These process of 1-hour drying, cooling, and weighing was repeated until a constant weight (W₂ g) was obtained. The ash content of the calcined materials were calculated from the following formula by using the obtained W₀ (weight of the crucible), W₁ (weight of the calcined material), and W₂ (total weight of the calcined and ashed material and the crucible). Table 1 shows the results:
Ash content of calcined material={(W₂·W₀)/W₁}×100 (%)

### Comparative Example 1

The ash content of the pre-calcined defatted sesame used in Examples 1 to 3 (un calcined materials) was measured in the same manner as in Example 1. Table 1 also shows the results.

TABLE 1

| | Calcining time (h) | Ash content (%) |
|---|---|---|
| Example 1 | 1 | 88.1 |
| Example 2 | 2 | 95.3 |
| Example 3 | 3 | 99.9 |
| Comparative Example 1 | 0 | 12.7 |

The results in Table 1 show that the longer the defatted sesame was calcined at 800° C., the higher the ash content of the obtained calcined material was. In particular, when the defatted sesame was calcined at 800° C. for 3 hours, the ash content in the calcined material was 99.9%, and thus a calcined material that contains substantially no oxalic acid and phytic acid was obtained.

### Example 4

### Preparation of Raw Material for Mineral Preparation

Defatted sesame (Lot No. 2) was loaded into an electric oven. The temperature was raised to 800° C., and the defatted sesame was calcined for 3 hours. Thus a calcined material (calcined material 4) was obtained.

Measurement of Minerals in Raw Material for Mineral Preparation

The contents of minerals (magnesium, calcium, potassium, and other mineral components) in the calcined material 3 obtained in Example 3, and those in the calcined material 4 obtained in Example 4 were measured by the analytical methods listed in Table 2 below. Table 3 shows the results.

TABLE 2

| | Analytical method |
|---|---|
| Magnesium | Atomic absorption spectrophotometry |
| Calcium | ICP emission spectrometry |
| Potassium | Atomic absorption spectrophotometry |
| Iron | o-Phenanthroline absorption spectrophotometry |
| Copper | Atomic absorption spectrophotometry |
| Zinc | Atomic absorption spectrophotometry |
| Manganese | Atomic absorption spectrophotometry |
| Selenium | Fluorophotometry |
| Sodium | Atomic absorption spectrophotometry |
| Phosphorus | Vanado molybdate spectrophotometry |

TABLE 3

| | | Example 3 | | Example 4 |
|---|---|---|---|---|
| | | Defatted sesame | | Defatted sesame |
| | | (Lot No. 1) | | (Lot No. 2) |
| | | Before | Calcined | Calcined |
| | | calcining | material 3 | material 4 |
| Major | Magnesium | 0.75 × 10³ | 7.09 × 10³ | 5.77 × 10³ |
| minerals | | (16.9)*¹ | (17.3)*¹ | (15.2)*¹ |
| | Calcium | 2.55 × 10³ | 23.7 × 10³ | 23.8 × 10³ |
| | | (57.3)*¹ | (57.7)*¹ | (63.0)*¹ |
| | Potassium | 1.15 × 10³ | 10.3 × 10³ | 8.23 × 10³ |
| | | (25.8)*¹ | (25.1)*¹ | (21.8)*¹ |
| Other | Iron | 44.1 | —*² | 858 |
| minerals | Copper | 3.78 | —*² | 25.4 |
| | Zinc | 11.3 | —*² | 60.4 |
| | Manganese | 5.52 | —*² | 52.7 |
| | Selenium | 91 × 10⁻³ | —*² | 0.33 |
| | Sodium | 23.3 | —*² | 138 |
| | Phosphorus | 1.26 × 10³ | 13.2 × 10³ | 10.4 × 10³ |

Unit mg/100 g
*¹Amount (wt %) of each mineral based on the total weight of the major minerals (i.e., magnesium, calcium, and potassium)
*²“—” in the table refers to “not measured”

The results in Table 3 show that the calcined materials of the defatted sesame (the calcined materials 3 and 4) contained minerals abundantly. In particular, the magnesium content was 5 g/100 g or more, the calcium content was 20 g/100 g or more, and the potassium content was 8 g/100 g or more. The results in Tables 1 and 3 show that these calcined materials have a low contents of oxalic acid and/or phytic acid, and the ratio of the major minerals (magnesium, calcium, and potassium) is high, so that it can be expected that a mineral preparation containing minerals that can be easily absorbed into the body can be obtained from these calcined materials.

### Examples 5 to 7

### Production 1 of Mineral Preparation

After the calcined materials (the calcined materials 1 to 3) obtained in Examples 1 to 3 were cooled to room temperature, an acidic aqueous solution or the like (5 to 20% of hydrochloric acid aqueous solution, sulfuric acid aqueous solution, lactic acid aqueous solution, lactic acid fermentation liquid, acetic acid aqueous solution, or acetic acid fermentation liquid (vinegar produced by fermentation)) was gradually added to each of these calcined materials (the calcined materials 1 to 3), and each of the resultant mixtures was thus stirred. Each of the acids and each of the calcined materials was reacted to produce gas (carbon dioxide), and thus, minerals in each of the calcined materials were eluted into the solution. The acidic aqueous solution was added until the gas production was stopped. The resultant mixture in which the reaction was ended was filtered to recover filtrate. This filtrate was spray dried, and thus a mineral preparation was obtained.

### Example 8

### Production 2 of Mineral Preparation

The defatted sesame employed in Example 1 was calcined at 800° C. for 3 hours by using an electric oven to be ashed, and thus a calcined material with 99.9% of ash content was obtained. Then, 425 g of this calcined material was placed in a reaction vessel, and 3 L of natural vinegar produced by fermentation (15% of acetic acid aqueous solution) was gradually added to the vessel while stirring. The mixture had a pH of 4.38. The mixture was allowed to stand overnight while stirring, so that minerals were eluted into the aqueous phase completely. Thereafter, the mixture was filtered to recover filtrate. This filtrate was spray dried at a temperature in the range of 145° C. to 150° C., and thus about 400 g of a solid material containing minerals (acetic acid-treated product of the calcined material of the defatted sesame) was obtained.

Separately, 405 g of the calcined material was placed in a reaction vessel, 630 g of lactic acid fermentation liquid (having 50 wt % of L-lactic acid) and 3.6 L of water were gradually added to the vessel while stirring, and the resultant mixture was stirred. The mixture had a pH of 4.98. The mixture was allowed to stand overnight at 60° C. while stirring, so that minerals were eluted into the aqueous phase completely. Thereafter, the mixture was filtered to recover filtrate. This filtrate was spray dried at 145° C. to 150° C., and thus about 400 g of a solid material containing minerals (lactic acid-treated product of the calcined material of the defatted sesame) was obtained.

The contents of minerals (magnesium, calcium, potassium, iron, copper, zinc, manganese, selenium, sodium, and phosphorus) in the defatted sesame before calcining, the acetic acid-treated product, and the lactic acid-treated product that were obtained in the above-mentioned manner were measured by using the analytical methods listed in the above Table 2. Table 4 shows the results.

### Comparative Example 2

An acetic acid-treated product and a lactic acid-treated product of a calcined material of sesame coats were obtained in the same manner as in Example 8 except that sesame coats were used instead of defatted sesame, and the contents of minerals in these treated products were measured. Table 4 also shows the results.

TABLE 4

| | | Defatted sesame | | | Sesame coats | |
|---|---|---|---|---|---|---|
| | | (Example 8) | | | (Comparative Example 2) | |
| | | Before | Acetic acid- | Lactic acid- | Acetic acid- | Lactic acid- |
| | | calcining | treated product | treated product | treated product | treated product |
| Major minerals | Magnesium | 0.75 × 10³ | 5.75 × 10³ | 4.83 × 10³ | 1.12 × 10³ | 0.91 × 10³ |
| | | (16.9)*¹ | (30.5)*¹ | (27.8)*¹ | (5.5)*¹ | (5.4)*¹ |
| | Calcium | 2.55 × 10³ | 4.77 × 10³ | 5.41 × 10³ | 18.1 × 10³ | 14.8 × 10³ |
| | | (57.3)*¹ | (25.3)*¹ | (31.1)*¹ | (89.1)*¹ | (88.2)*¹ |
| | Potassium | 1.15 × 10³ | 8.36 × 10³ | 7.13 × 10³ | 1.10 × 10³ | 1.07 × 10³ |
| | | (25.8)*¹ | (44.3)*¹ | (41.0)*¹ | (5.4)*¹ | (6.4)*¹ |
| Other minerals | Iron | 44.1 | 0 | 10.2 | 1.20 | 43.1 |
| | Copper | 3.78 | 9.47 | 11.1 | 1.52 | 0.49 |
| | Zinc | 11.3 | 9.65 | 12.9 | 2.91 | 0.29 |
| | Manganese | 5.52 | 0.09 | 17.3 | —*² | —*² |
| | Selenium | 91 × 10⁻³ | 0.24 | 0.22 | —*² | 8 × 10⁻³ |
| | Sodium | 23.3 | 113 | 105 | 22.9 | 56.3 |
| | Phosphorus | 1.26 × 10³ | 668 | 462 | —*² | —*² |

Unit: mg/100 g
*¹Amount (wt %) of each mineral based on the total weight of the major minerals (i.e., magnesium, calcium, and potassium)
*²“—” in the table refers to “lower than the detection limit”

The results in Table 4 show that the acetic acid-treated product and the lactic acid-treated product of the calcined material of the defatted sesame contained large amounts of magnesium, calcium, and potassium in a well-balanced manner. In particular, the ratio of the magnesium in the major minerals (i.e., magnesium, calcium, and potassium) contained in the treated products of the defatted sesame was high, namely, 20 wt % or more. By contrast, the ratio of the magnesium in the major minerals contained in each of the acetic acid-treated product and the lactic acid-treated product of the calcined material of the sesame coats in the comparative example, was 5.5 wt % or less. The amount of the calcium was 25 wt % or more, and the amount of the potassium was 40 wt % or more based on the weight of the major minerals contained in the above-described treated products of the defatted sesame.

According to the present invention, a mineral preparation is obtained from defatted sesame which is industrial waste. The mineral preparation has low contents of oxalic acid and/or phytic acid and contains minerals that can be absorbed into the body effectively. In particular, the mineral preparation has high contents of magnesium, calcium, and potassium and has a particularly high content of magnesium. It is possible to ingest minerals effectively by ingesting the mineral preparation of the present invention. In the mineral preparation of the present invention, defatted sesame, which is a by-product in the production of sesame oil, can be used effectively. The mineral preparation of the present invention also can be used in the fields of, for example, food or medicine.

The present invention may be embodied in other forms without departing from the spirit or essential characteristics thereof The embodiments disclosed in this application are to be considered in all respects as illustrative and not limiting. The scope of the present invention is indicated by the appended claims rather than by the foregoing description, and all changes which come within the meaning and range of equivalency of the claims are intended to be embraced therein.

1. A raw material for a mineral preparation obtained by calcining defatted sesame.

2. A method for producing a raw material for a mineral preparation, comprising calcining defatted sesame.

3. A mineral preparation, comprising minerals obtained from a raw material obtained by calcining defatted sesame.

4. The mineral preparation of claim 3, wherein the mineral preparation comprises magnesium, calcium, and potassium, and wherein a ratio of the magnesium is 20 wt % or more based on the total weight of the magnesium, calcium, and potassium.

5. A method for producing a mineral preparation, comprising:
calcining defatted sesame to obtain a raw material for mineral preparation,
mixing the raw material for a mineral preparation and an acidic aqueous solution, and
recovering the resultant aqueous phase.

6. A method for obtaining minerals from defatted sesame, comprising:
calcining defatted sesame to obtain a raw material for a mineral preparation,
mixing the raw material for a mineral preparation and an acidic aqueous solution, and
recovering the resultant aqueous phase.
